(19) United States
(12) Patent Application Publication
(10) Pub. No.: US 2008/0162710 A1
(43) Pub. Date: Jul. 3, 2008

(54) SYSTEM AND METHOD FOR PROVIDING MESSAGES FROM A FIXED COMMUNICATION DEVICE VIA A GATEWAY

(75) Inventors: Satish Kumar M. Mundra, Germantown, MD (US); Manoj Sindhwani, Oakhill, VA (US); Satyamurthy Yadavalli, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/962,639

(22) Filed: Dec. 21, 2007

Related U.S. Application Data
(60) Provisional application No. 60/877,264, filed on Dec. 27, 2006.

(51) Int. Cl. G06F 15/16

(52) U.S. Cl. 709/230

(57) ABSTRACT

A fixed communication device includes a transceiver operable to transmit and receive communications to a gateway, and a processor cooperatively operable with the transceiver. The processor is configured to facilitate establishing a foreign exchange office (FXO) connection to the gateway over the transceiver; formatting a message in a multiple data message format (MDMF) message format; and transmitting the message from the transceiver to the gateway using frequency shift keying (FSK) modulation, after the FXO connection is established

### CROSS-REFERENCE TO RELATED APPLICATIONS

This application claims the benefit of the U.S. Provisional Application No. 60/877,264 filed Dec. 27, 2006, which is expressly incorporated herein by reference.

### TECHNICAL FIELD

The technical field relates in general to communications between a residential gateway and a fixed communication device connected to the gateway for access to Internet telephony, and more specifically, to the provisioning of a protocol to provide enhanced functionality to fixed communication devices.

### BACKGROUND

Residential gateways (sometimes referred to as service gateways, home gateways, and access devices) are a key part of the home networking solution. They provide a platform for integrating different broadband access technologies and several home networking solutions. A residential gateway can connect a local area network (LAN) in a home to the Internet. A hardware device similar to a router, the residential gateway provides a unique combination of features.

By definition, a gateway joins two networks together. Gateway hardware exists in multiple forms including general-purpose servers with multiple network adapters and routers. Traditional gateways have been installed in server rooms or closets, but residential gateways bring these devices into the home. Home gateways vary significantly in their capabilities, so that no one “typical” home gateway exists. However, most residential gateways support some basic features, broadband (often DSL (digital subscriber line)) service connectivity, Internet connection sharing and firewall security. This connectivity can bring VoIP (voice over Internet protocol) into the local network, allowing the connection of a telephone system to VoIP through the gateway.

By connecting the home or small office network to the Internet, a residential gateway provides translation and allows access to a DSL or cable modem Internet connection. The residential gateway sits between the DSL or cable modem which downloads and uploads data, voice, and video, and provides Internet access and an internal network. Alternately, a DSL or cable modem might be integrated into the residential gateway.

### SUMMARY

Accordingly, one or more embodiments provide methods, systems, and devices, such as a fixed communication device including a transceiver operable to transmit and receive communications to a gateway; and a processor cooperatively operable with the transceiver. The processor can be configured to facilitate establishing a foreign exchange office (FXO) connection to the gateway over the transceiver; formatting a message in a multiple data message format (MDMF) message format; and transmitting the message from the transceiver to the gateway using frequency shift keying (FSK) modulation, after the FXO connection is established.

Further embodiments provide a foreign exchange station (FXS) gateway, including a transceiver operable to transmit and receive communications to a fixed communication device; and a processor cooperatively operable with the transceiver. The processor can be configured to facilitate receiving a message in a multiple data message format (MDMF) message format from the fixed communication device over the transceiver.

Still other embodiments provide a computer-readable medium comprising instructions for execution by a computer, the instructions including a computer-implemented method for providing messages from a fixed communication device via a foreign exchange station (FXS) gateway. The instructions can implement the step of receiving a message in a multiple data message format (MDMF) message format from a fixed communication device.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a diagram illustrating a simplified and representative environment associated with a fixed communication device and a gateway;

FIG. 2 is a block diagram illustrating portions of a gateway;

FIG. 3 is a block diagram illustrating portions of a fixed communication device;

FIG. 4 is a block diagram illustrating portions of a MDMF (multiple data message format) message;

FIG. 5 is a packet flow diagram illustrating a flow of messages for providing dialing from a fixed communication device via a gateway;

FIG. 6 is a flow chart illustrating an exemplary procedure for providing MDMF access, including dialing via an MDMF message with a contact address; and

FIG. 7 is a flow chart illustrating an exemplary procedure for transmitting an MDMF message, including a message with a contact address.

### DETAILED DESCRIPTION

In overview, the present disclosure concerns gateways and fixed communication devices which are configured to connect together, and wherein a gateways are further connected between fixed communication devices and communication networks, often referred to as voice over packet (VOP) networks, such as may be associated with networks supporting voice communication. Such communication networks may provide additional services such as data communications, signal, and/or video services. Such communication networks can include network infrastructure devices which transfer the communications between endpoints, for example by forwarding the communications which may have been broken into communication packets and may be reassembled. More particularly, various inventive concepts and principles are embodied in systems, devices, and methods therein for providing communications between a gateway and a fixed communication device, optionally in a VOP network environment, to provide MDMF (multiple data message format) messages from the fixed communication device.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such F software and ICs, if any, will be limited to the essentials with respect to the principles and concepts used by the exemplary embodiments.

As further discussed herein below, various inventive principles and combinations thereof are advantageously employed so that a fixed communication device can dial based on FSK modulation, which can bridge the service and experience gap between fixed communication devices and gateways.

A communication protocol for phones attached to VoIP gateways provides for enhanced communication between a fixed communication device which can only communicate with DTMF signals and a residential gateway which provides access to the Internet. Using FSK and/or DTMF signaling, the present disclosure provides phone access to a set of IP phone capabilities which can include advanced dialing. A conventional residential gateway used for VoIP presents a barrier to the flow of additional and enhanced telephony information. VoIP signaling protocols such as SIP, used by IP phones and software phones, provide enhanced capabilities which are enabled for the telephone by the present disclosure.

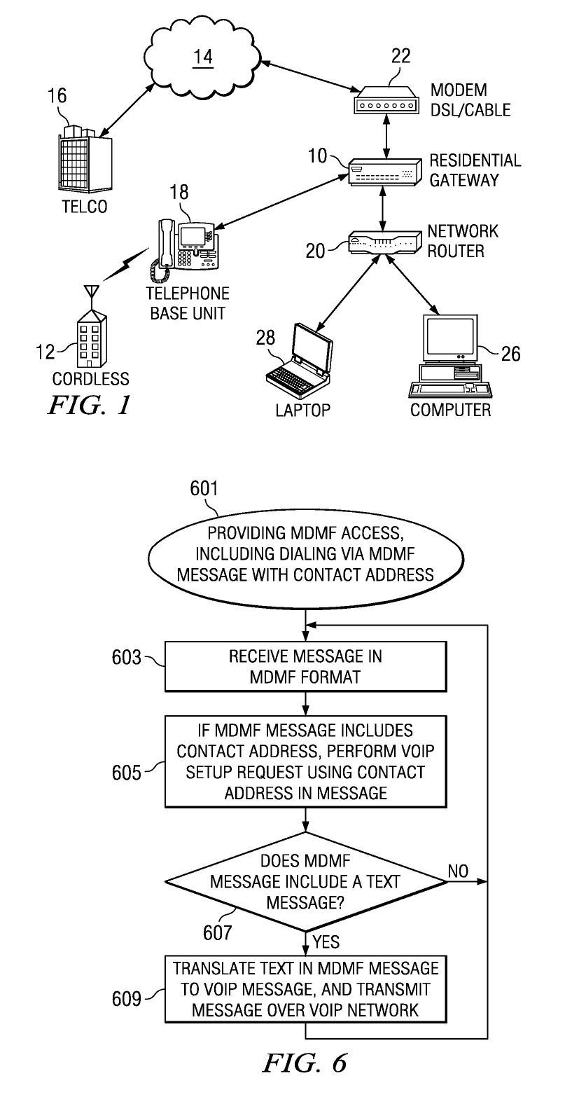

Referring now to FIG. 1, a diagram illustrating a simplified and representative environment associated with a fixed communication device and a gateway will be discussed and described. The illustration of FIG. 1 includes a typical residential gateway (RGW) interconnection. The residential gateway 10, if used for telephony, such as VoIP, will connect to a home phone 12, for example, through a network router 20, and connect the home phone 12 to the Internet 14, for example through a modem 22. Although a residential gateway 10 provides connectivity, when used for VoIP, a residential gateway 10 traditionally presents a barrier to the flow of additional and enhanced telephony information from the telco central office 16 to the residential phone 12. A residential gateway 10, although connected to the Internet 14 and able to communicate with other parties, does not readily pass any information through to the telephone 12, which acts like a POTS (plain old telephone service) phone and only receives limited data, such as telephone numbers.

A cordless phone system having a base unit 18 and individual cordless hand sets 12, attached to an FXS (foreign exchange station) port of the residential gateway 10, can build an address book when a calling party's name and numbers are delivered to them. When dialing from this address book, conventionally only a number is sent as DTMF (dual-tone multi-frequency) digits; there is no conventional way to send the name data associated with the stored number from the phone system to the gateway 10. VoIP signaling protocols such as SIP (session initiation protocol), used by IP (Internet protocol) phones and software phones (such as those which may reside in personal computer (PC) 26 or laptop 28) provide the ability to add a called party's name in addition to the DTMF number, for example, in an INVITE message. Use of the called party's name can enable features such as Distinctive Ringing or Direct Inward Dialing (DID).

Some callers using IP Phones or Soft Phones may have the address in the form of a SIP URL (uniform resource locator) such as sip:xyz@abc.com and there may not be any number associated. There is no simple way for dialing such calls through a conventional RGW. Protocols for enabling the display of diagnostic and informative messages including short text message delivered using services such as IM (instant messaging) or SMS (short message service) are used in Internet telephony. However, there is no simple way to send short text messages using services such as IM or SMS using non IP phones attached to conventional RGWs.

A cordless phone system can distinguish between various handsets on its system and can also configure names for the handsets. Distinguishing between headsets can provide an additional level of individual identity beyond caller ID (CID). However, there is no trivial way for delivering this information to the conventional RGW. Delivery of name information could be used by the VoIP in the display name field in the FROM header in SIP INVITE messages, allowing receivers to correctly identify the caller as there could be multiple users of the phone line in a home having a common CID, however this capability is not conventionally available.

There is also no natural way to distinguish voice band events such as DTMF digits and signaling events that are composed of DTMF digits. Typically some digits such as * are reserved for indicating start of a DTMF digit string to enable distinction between signaling events and voice band DTMF digit events. This typically can lead to conflicting behavior or inconvenience to listeners or confusion with IVR (interactive voice response) system interaction.

The issues listed above are some examples and by no means an exhaustive list of limitations that the inventors have noted which conventional RGW users experience even while using a VoIP network infrastructure.

The present disclosure teaches the implementation of one or more communication protocols between the ROW 10 and the residential telephone system 24. The protocol provides a new dialing mode based on frequency shift keying (FSK) modulation analogous to the CID message delivery mechanism, which will enable phones to overcome the limitations listed above and bridge the service and experience gap between IP Phones and RGWs. The protocol also establishes an interoperability connection so that a user can dial predefined feature codes that retrieve device 10 configuration information for display on the CID display of the hand sets 12.

As described above, one primary limitation that prevents an RGW from providing services beyond those offered by PSTN (public switched telephone network) enhanced user experience is the inability of phones to send or signal anything other than DTMF digits and their associated speed of delivery. In addition, DTMF digits must have minimum on-time and off-time to be recognized as valid digits. The present disclosure teaches a new dialing mechanism that overcomes this limitation allowing phones to send text and digits or other signaling events using a new protocol.

Most phones are capable of receiving simple FSK modulated data transmitted from a switch and are capable of demodulating the calling party name, number and time information presented in MDMF (multiple data message format) (for NA (Network Aspects group), ETSI (European Telecommunications Standards Institute)) message format for display on an attached screen. The FSK modulation used by the phones for dialing to deliver name and number information to a switch is also used as the same MDMF message format and scheme for dialing. Using the same message format reduces the implementation complexity. With this implementation, the phone can deliver any alpha-numeric message or string to a switch. Various organizations such as Telcordia and ETSI have defined a number of message types and sub-types that identify various information such as calling party name, called party name etc. The present specification extends the message types and sub-types further for other useful purposes which include IM, SMS, informative, diagnostic, and control messages.

Typically voice band data transmission using FSK modulation has been common in the Switch to Phone direction. By enabling the Phones to use the very same mechanism in the phone to switch direction at call setup or other times during the call instead of relying on DTMF digits alone would eliminate the problems described in previous section and allow a switch (the RGW in this case) to provide range of new services.

A user can browse through address lists and select one of the entries upon which the phone will create a MDMF message that will include the selected Name, Number as destination and optionally append the configured calling party Name and Number and send the message allowing the RGWs to fully populate, for example, the SIP INVITE message.

Similarly a SMS or IM text message can be appended for delivery using IM or SMS protocol. Other services such as delivering current location/address for routing emergency calls which could be enabled by service providers for RGW users. FSK dialing enables development of new features and services for RGW taking full advantage of the VoIP signaling protocols and transport. The dialing mechanism taught by the present disclosure brings the IP phone or cellular telephone-like capabilities to phones attached to RGWs.

FSK dialing provides gateways with VoDSL (voice over DSL) and/or VoCM (voice over cable modem), a distinct advantage when supporting dialing modes taught herein. The benefits of VoIP service features and applications can be available to telephone users that access the Internet through a residential gateway. The switch to IP telephony is a necessity in business environments and residential user experience can be raised above and beyond what is available from PSTN.

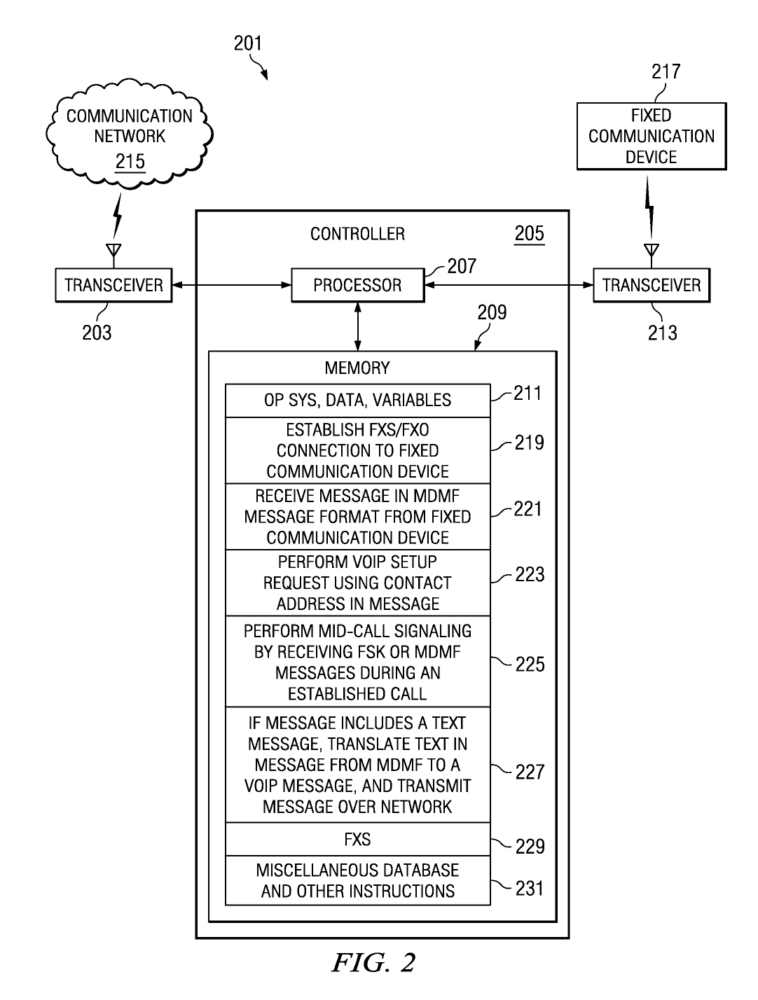

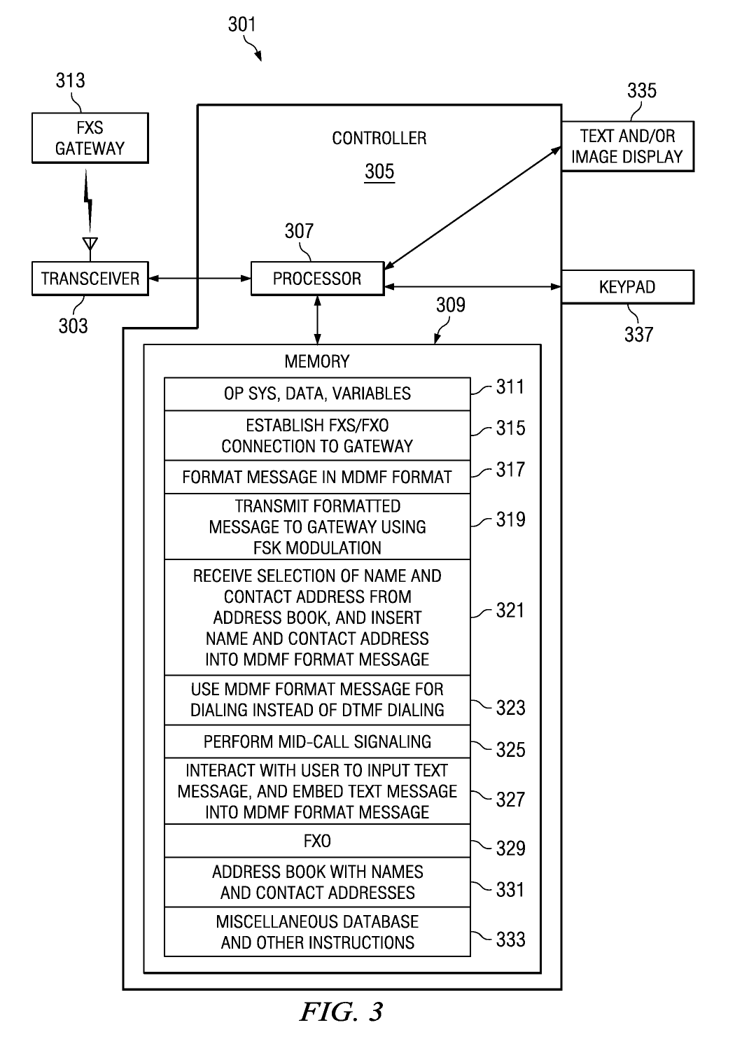

FIG. 2 illustrates portions of a gateway, and FIG. 3 illustrates portions of a fixed communication device. Each is discussed separately in the following paragraphs.

Referring now to FIG. 2, a block diagram illustrating portions of a gateway will be discussed and described. The gateway 201 may include a first transceiver 203 for communicating over the communication network 215, a second transceiver 213 for communicating with a fixed communication device 217, and one or more controllers 205. The first transceiver 203 is representative of a combination of any number of transmitters and/or receivers, and may have a wireless or wired connection to the communication network 215. Also, the second transceiver 213 can be representative of a combination of transmitters and/or receivers and may have a wireless or wired connection to the fixed communication device 217.

The controller 205 may include a processor 207, a memory 209, and other optional components which will be well understood to those in this field. A display, a keyboard, and/or other display and input device for interacting with the user, such as a track ball, console, keypad, and/or similar optionally can be provided with the gateway 201.

The processor 207 may be, for example, one or more microprocessors and/or one or more digital signal processors. The memory 209 may be coupled to the processor 207 and may comprise a read-only memory (ROM), a random-access memory (RAM), a read/write flash memory, a programmable ROM (PROM), and/or an electrically erasable read-only memory (EEPROM). The memory 209 may include multiple memory locations for storing, among other things, an operating system, data and variables 211 for programs executed by the processor 207; computer programs for causing the processor to operate in connection with various functions such as establishing 219 an FXS/FXO connection to a fixed communication device, receiving 221 a message in MDMF message format from the fixed communication device, performing 233 a VoIP setup request using a contact address in the message, performing 225 mid-call signaling by receiving FSK or MDMF message during an established call, and if a message includes a text message, translating 227 text in the message from MDMF to a VoIP message, and transmitting the message over the communication network; an FXS interface; and a database 231 of various information and other instructions used by the processor 207. The computer programs may be stored, for example, in ROM or PROM and may direct the processor 207 in controlling the operation of the gateway 201. Each of these computer programs is discussed by way of example below.

The processor 207 may be programmed for establishing 219 an FXS/FXO connection to a fixed communication device 217. For example, the fixed communication device 217 can go off-hook, or DTMF tones can be received at the second transceiver 213. Conventional techniques can be used for establishing the FXS/FXO connection to the fixed communication device 217 in cooperation with the FXS interface 231.

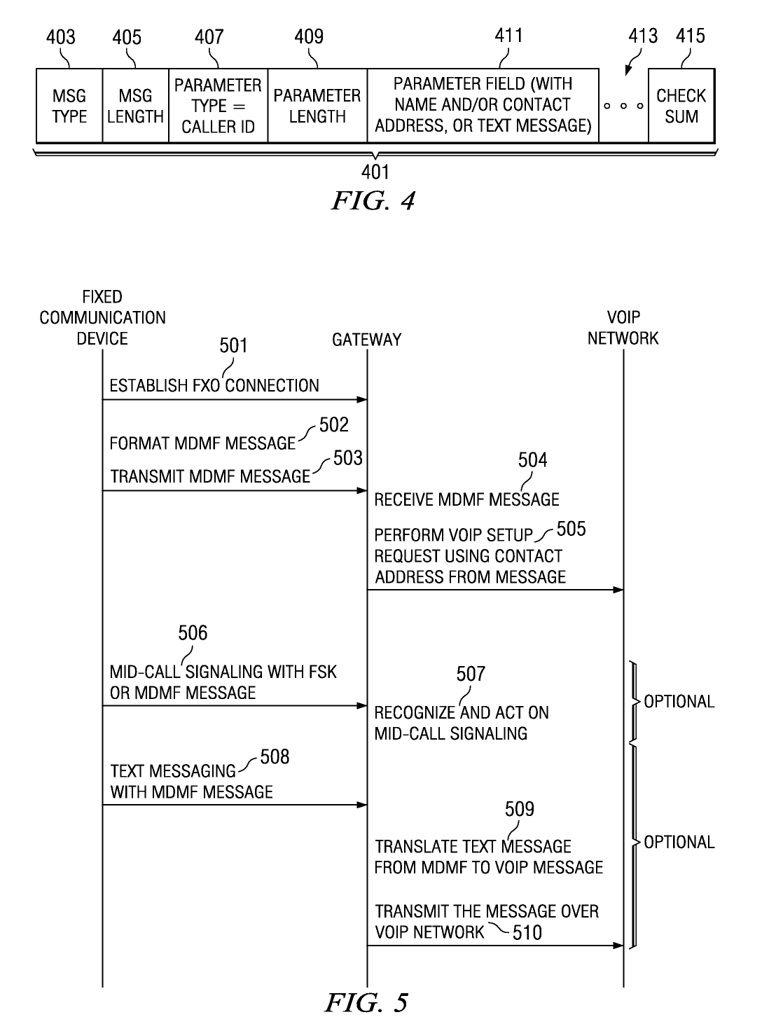

Further, the processor 207 may be programmed for receiving 221 a message in MDMF message format from the fixed communication device. That is, a message in MDMF format may be received from the fixed communication device 217 over the second transceiver 213. More particularly, the second transceiver 213 can receive information as a voice band data transmission using FSK modulation, instead of relying on DTMF digits. The information is a message in conventional MDMF format. The FSK modulation can be accomplished using known techniques. The MDMF message received at the processor 207 over the second transceiver 213 can include various parameters, discussed for example in connection with FIG. 4. Information passed in the MDMF message can include name and/or contact address, or a text message; name, contact address and/or text message would be included in the MDMF message as type/length/value fields, where type can be pre-defined. Accordingly, one or more embodiments provide for detecting the FSK modulation signals from the fixed communication device.

The processor 207 can also be programmed for performing 233 a VoIP setup request using a contact address, if any, in the MDMF message. The VoIP setup request is performed according to conventional techniques, using the contact address as the destination, for example the destination telephone number or URL, as appropriate. The VoIP setup is performed as usual between the requested contact address and the fixed communication device 217. However, in this case, the contact address was provided from the MDMF message, rather than from standard DTMF dialing.

Also, the processor 207 can be programmed for performing 225 mid-call signaling by receiving a FSK or MDMF message during an established call. That is, an FSK modulation or MDMF message can be received from the fixed communication device 217 at the processor 207 over the second transceiver 213. If a MDMF message is received by the processor 207 during an established call, that is, an on-going call between the fixed communication device 213 and a destination, the parameters in the MDMF message (such as discussed in connection with FIG. 3) can be extracted from the MDMF message. If FSK modulation is received during an established call, then the information transmitted by the FSK modulation is similarly extracted. The use of mid-call signaling can advantageously be used in place of conventional hook-flash techniques, for example for conference, transfer, forward, and other hook-flash commands. Furthermore, the processor 207 can be programmed to facilitate the action requested in the FSK or MDMF message received during mid-call signaling, for example, conferencing in, transferring to, or forwarding to a contact address specified in the FSK or MDMF message.

Accordingly, one or more embodiments provide for making a determination whether the fixed communication device uses dual tone multi-frequency (DTMF) modulation or frequency shift keying (FSK) modulation.

Moreover, the processor 207 can be programmed for, if a message includes a text message, translating 227 a text message in the message from MDMF to a VoIP message, and transmitting the message over the communication network. That is, if the MDMF message includes a text message (in accordance with short message service (SMS) standards and variations thereof), the text in the message is translated from MDMF form to a VoIP message. The VoIP message can be transmitted by the processor 207 from the first transceiver 203 over the communication network 215, in accordance with conventional techniques.

Moreover, a computer-readable medium may include instructions for execution by a computer, the instructions including a computer-implemented method for providing dialing from a fixed communication device via a foreign exchange station.

The processor 207 can be provided with additional functions, such as an FXS interface 229. The FXS interface can manage a conventional FXS/FXO connection to the fixed communication device 217 in accordance with known techniques.

Also illustrated is the miscellaneous database 231 of various information used by the processor 207. The database 231 is provided for local storage of information.

Accordingly, one or more embodiment provide a foreign exchange station (FXS) gateway, including a transceiver operable to transmit and receive communications to a fixed communication device; and a processor cooperatively operable with the transceiver. The processor is configured to facilitate receiving a message in a multiple data message format (MDMF) message format from the fixed communication device over the transceiver.

Referring now to FIG. 3, a block diagram illustrating portions of a fixed communication device will be discussed and described. The fixed communication device 301 may include a transceiver 303 for communicating with an FXS gateway 313, and one or more controllers 305. The transceiver 303 is representative of a combination of any number of transmitters and/or receivers, and may have a wireless or wired connection to the FXS gateway 313.

The controller 305 may include a processor 307, a memory 309, and other optional components which will be well understood to those in this field. A text and/or image display 335, a keypad 337, and/or other display and input device for interacting with the user, such as a track ball, console, keyboard, and/or similar optionally can be provided with the fixed communication device 301.

The processor 307 may be, for example, one or more microprocessors and/or one or more digital signal processors. The memory 309 may be coupled to the processor 307 and may comprise a read-only memory (ROM), a random-access memory (RAM), a read/write flash memory, a programmable ROM (PROM), and/or an electrically erasable read-only memory (EEPROM). The memory 309 may include multiple memory locations for storing, among other things, an operating system, data and variables 311 for programs executed by the processor 307; computer programs for causing the processor to operate in connection with various functions such as establishing 315 an FXS/FXO connection to a gateway, formatting 317 a message in MDMF format, transmitting 319 the formatted message to the gateway using FSK modulation, receiving 321 a selection of name and contact address from the address book and inserting the name and contact address into the MDMF format message, using 323 the MDMF format message for dialing instead of DTMF dialing, performing 325 mid-call signaling, interacting 327 with a user to input a text message and embedding the text message into an MDMF format message; an FXO interface 329; an address book 331 with names and contact address; and a database 333 of various information and other instructions used by the processor 307. The computer programs may be stored, for example, in ROM or PROM and may direct the processor 207 in controlling the operation of the fixed communication device 301. Each of these computer programs is discussed by way of example below.

The processor 307 may be programmed for as establishing 315 an FXS/FXO connection to the FXS gateway 313, for example by going off-hook or by transmitting DTMF tones to the FXS gateway 313 over the transceiver 303, according to conventional techniques, in cooperation with the FXO interface 329.

The processor 307 also can be programmed for formatting 317 a message in MDMF format. That is, a message can be created which is in MDMF format, as discussed in more detail in connection with FIG. 4.

Furthermore, the processor 307 can be programmed for transmitting 319 the formatted message to the gateway using FSK modulation. That is, the message that is MDMF format can be transmitted to the gateway 313 over the transceiver 303, using conventional FSK modulation techniques.

Also, the processor 307 can be programmed for receiving 321 a selection of name and contact address from the address book and inserting the name and/or contact address into the MDMF format message. The address book 331 can be traversed and a name and/or contact address can be selected, according to known techniques. The contact address and/or the name that was selected can be inserted into the parameter field of the MDMF format message. This message can then be transmitted to the gateway, as described above.

Accordingly, one or more embodiments provide for a memory storing an address book, wherein the processor is further configured to receive a selection of a name and a contact address from the address book, and to insert the name and the contact address into MDMF message format in the message prior to the transmitting.

The processor 307 also can be programmed for using 323 the MDMF format message for dialing instead of DTMF dialing. For example, the when the name and/or contact address is selected, the processor 307 can transmit the MDMF format message to the FXS gateway (as described above), instead of performing a conventional dialing utilizing DTMF techniques. The FXS gateway 313 is expected to contact the contact address over the VOP network.

The processor 307 can be programmed for performing 325 mid-call signaling without resorting to hook-flash techniques. The mid-call signaling information can be placed into an MDMF message together with pre-defined parameters defining the mid-call signal request. Mid-call signal requests can be, for example, conference in a destination contact address, transfer an existing call to the destination contact address, or forward calls to the destination contact address, or the like. The MDMF message for the mid-call signaling can include the destination contact address.

Also, the processor 307 can be programmed for interacting 327 with a user to input a text message and embedding the text message into an MDMF format message. More particularly, the user can interact with the processor 307, for example, using the keypad 337 and by referring to the test and/or image display 335, to create a text message, optionally selecting a name and/or contact address from the address book 331 to which the text message is to be sent. The text, optionally with the selected name and/or contact address (if any), can be inserted along with appropriate parameters into an MDMF message. The MDMF message can be transmitted to the gateway as described above, without using DTMF.

Furthermore, the processor 307 can be provided with additional functions, such as an FXO interface 329, which can manage a conventional FXS/FXO connection to the FXS gateway 313 in accordance with known techniques.

Accordingly, one or more embodiments provides for a fixed communication device, including a transceiver operable to transmit and receive communications to a gateway; and a processor cooperatively operable with the transceiver. The processor can be configured to facilitate establishing a foreign exchange office (FXO) connection to the gateway over the transceiver; formatting a message in a multiple data message format (MDMF) message format; and transmitting the message from the transceiver to the gateway using frequency shift keying (FSK) modulation, after the FXO connection is established.

It should be understood that various embodiments are described in. FIG. 2 and FIG. 3 in connection with logical groupings of functions. One or more embodiments may omit one or more of these logical groupings. Likewise, in one or more embodiments, functions illustrated in FIG. 2 or FIG. 3 may be grouped differently, combined, or augmented.

Referring now to FIG. 4, a block diagram illustrating portions of a MDMF (multiple data message format) message will be discussed and described. A message 401 in MDMF format includes a message type 403, a message length 405, a parameter type 407 (here, caller ID), a parameter length 409, a parameter field 311 (here, the caller ID field, nevertheless containing name and/or contact address, or text message), one or more optional sequences of additional parameter types, parameter lengths and parameter fields (here represented by optional additional parameter 413) and a check sum 415.

The MDMF message 401 can include a telephone number using conventional parameter types (caller ID). The telephone number can be the desired contact address that is to be dialed.

Furthermore, a name is a conventional parameter type for an MDMF message. The name can be included as an optional additional parameter 413. The name can be the desired contact address, for example an e-mail address.

Accordingly, one or more embodiments provide that the message includes a contact address in accordance with the MDMF message format. Also, one or more embodiments provide that the message further includes both a name and a contact address in the MDMF message format.

The MDMF message 401 can include a text message, for example using a pre-defined parameter type to indicate text message If the MDMF message 401 includes a text message, it can be convenient to include a name and/or telephone number as an optional additional parameter 413, where the name is the desired contact address.

The MDMF message 410 can indicate a mid-call signal, using a pre-defined parameter type to indicate the kind of mid-call signal, together with the optional additional parameter 413 containing a destination contact address and/or name to be used with the mid-call signaling.

Combinations of the telephone number, name, text message and/or mid-call signal can be included, if desired, in a single MDMF message that has multiple parameters, each with their own parameter type 407, parameter length 409, and parameter field 411.

Additional fields may be included in the MDMF message according to known formats, however, they are not illustrated here to avoid obscuring the principles discussed herein. It should be noted that MDMF messages are conventionally not transmitted from a fixed communication device to a gateway.

Referring now to FIG. 5, a packet flow diagram illustrating a flow of messages for providing dialing from a fixed communication device via a gateway will be discussed and described. In overview, blocks 501, 502, 503, 504 and 505 illustrate dialing from a fixed communication device using an MDMF message; blocks 506 and 507 illustrate mid-call signaling from a fixed communication device to a gateway using an FSK or MDMF message; and blocks 508, 509, and 510 illustrate text message from the fixed communication device using a MDMF message. The sequence of the mid-call signaling and text messaging illustrated in FIG. 5 is representative of any order, and any number, of mid-call signaling and text messaging.

Blocks 501, 502, 503, 504 and 505 illustrate dialing from a fixed communication device using an MDMF message. At block 501, the fixed communication device establishes an FXO connection to the gateway. At block 502, the fixed communication device formats an MDMF message, for example including a contact address, to be used as a destination for a call.

At block 503, the fixed communication device transmits the MDMF message (with the contact address) to the gateway, to cause the gateway to setup a call over a VoIP network with the contact address as a destination. Accordingly, one or more embodiments provide that the message in the MDMF message format is transmitted to be used for dialing instead of utilizing dual tone multi-frequency (DTMF) dialing.

At block 504, the gateway receives the MDMF message in accordance with the usual FSK techniques.

At block 505, the gateway performs a standard VoIP setup request, however using the contact address from the MDMF message as the destination. The VoIP setup request thereafter proceeds between the gateway and the VoIP network and the fixed communication device in accordance with normal techniques. Accordingly, one or more embodiments provide that the message received in the MDMF message format is used for dialing instead of utilizing DTMF dialing. Also, embodiments provide for performing a voice over Internet protocol (VOIP) setup request using a contact address in the message.

Blocks 506 and 507 illustrate mid-call signaling from a fixed communication device to a gateway using an FSK or MDMF message. In block 506, a call has been established from the fixed communication device to a destination. The fixed communication device transmits mid-call signaling with FSK or an MDMF message, as discussed above. Accordingly, one or more embodiments provide for performing mid-call signaling by transmitting FSK or MDMF messages to the gateway over the transceiver during an established call.

In block 507, the gateway receives the FSK or MDMF message, and acts on the mid- call signaling, also as discussed above. Accordingly, one or more embodiments provide for performing mid-call signaling by receiving FSK or MDMF messages from the fixed communication device over the transceiver during an established call.

Blocks 508, 509, and 510 illustrate text messaging from the fixed communication device using a MDMF message. In block 508, the fixed communication device transmits an MDMF message with text messaging to the gateway. The gateway receives the MDMF message, and in block 509, the gateway translates the text message from the MDMF message to a VoIP message. At block 510, the gateway transmits the VoIP message over the VoIP network, in accordance with conventional techniques. The details for these blocks have been discussed above. Accordingly, one or more embodiments provide for making a check whether the message includes a text message; and when the check is that the message includes the text message, translating the text in the message from MDMF form to a VOIP message, and transmitting the message over a VOIP network.

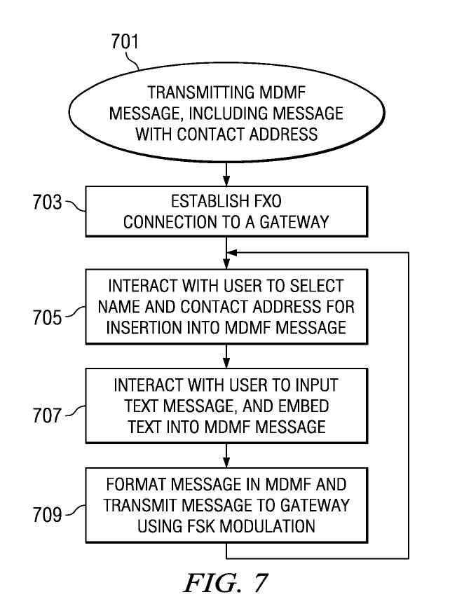

FIG. 6 and FIG. 7 are flow charts illustrating procedures that support MDMF access between a fixed communication device and a gateway. FIG. 6 illustrates providing the MDMF access, in which the illustrated example provides dialing via MDMF messaging. FIG. 7 illustrates transmitting the MDMF message to initiate the dialing. The procedure of FIG. 6 can advantageously be implemented on, for example, a processor of a gateway, described in connection with FIG. 2 or other apparatus appropriately arranged, whereas the procedure of FIG. 7 can advantageously be implemented on, for example, a processor of a fixed communication device as described in connection with FIG. 3 or other apparatus appropriately arranged.

Referring now to FIG. 6, a flow chart illustrating an exemplary procedure for providing MDMF access, including dialing via an MDMF message with a contact address will be discussed and described. In overview, the procedure for providing MDMF access 601, including dialing via an MDMF message with contact address, includes receiving 603 a message in MDMF format; if 605 the MDMF message includes a contact address, performing a VoIP setup request using the contact address in the MDMF message; checking 607 whether the MDMF message includes a text message, and if so, translating 609 the text in the MDMF message to a VoIP message, and transmitting the VoIP message over a VoIP network. Each of these is described in below, although the detailed description omits portions which were described above in detail.

The procedure 601 includes receiving 603 a message in MDMF format. The procedure also includes, if 605 the MDMF message includes a contact address, performing a VoIP setup request using the contact address in the MDMF message. For example, the parameter fields can be checked to determine whether a contact address is included. If there is a contact address, then a conventional VoIP setup request can be issued.

The procedure 601 can also include checking 607 whether the MDMF message includes a text message. For example, the parameter fields can be checked to determine whether a text message is included in the MDMF message. The procedure 601 also provides for, if the MDMF message includes a text message, translating 609 the text in the MDMF message to a VoIP message, and transmitting the VoIP message over a VoIP network. For example, the procedure 601 can copy the text message into a VoIP format message, and set up the fields in the VoIP message for a text message. Optionally, the destination for the VoIP message can be a contact address in a parameter field in the MDMF message; such a destination can be included in the VoIP message. The VoIP message can then be transmitted in accordance with known techniques.

Referring now to FIG. 7, a flow chart illustrating an exemplary procedure for transmitting an MDMF message, including a message with a contact address, will be discussed and described. In overview, the procedure for transmitting an MDMF message 701, including a message with a contact address, includes establishing 703 an FXO connection to a gateway; interacting 705 with a user to select a name and contact address for inserted into an MDMF message; optionally interacting 707 with a user to input a text message, and embedding the text into the MDMF message; and formatting 709 the message in MDMF and transmitting the formatted message to the gateway using FSK modulation. Each of these is described in below, although the detailed description omits portions which were described above in detail.

The procedure 701 includes establishing 703 an FXO connection to a gateway, as described previously. The procedure 701 then provides for interacting 705 with a user to select a name and contact address to be inserted into an MDMF message, for example, by selecting a name or contact address from an address book or optionally manually entering the contact address.

The procedure 701 optionally provides for interacting 707 with a user to input a text message, and embedding the text into the MDMF message. That is, if the user selects to input a text message, the user can manually enter the text message. The input message is placed into the appropriate field of the MDMF message.

Furthermore, the procedure 701 includes formatting 709 the message in MDMF and transmitting the formatted message to the gateway using FSK modulation, as described above in more detail. The MDMF message can include one or more of the following: contact address, text message, and/or mid-call signaling.

The term “contact address” is used herein to indicate a telephone number or a SIP (session initiation protocol) URL (uniform resource locator) or an e-mail address.

The term “FSK” as used herein is intended to indicate various Frequency Shift Keying (FSK) standards used in various countries across the globe, including the ETSI FSK (European Telecommunications-1 and -2, ES 200 778-1 and -2, ETS 300 778-1 and -2), Bellcore FSK, BT (British Telecom) FSK and CCA (Cable Communication Association) FSK, and variations and evolutions thereof.

The term “MDMF” is used herein to indicate multiple data message format standards, for example, the presentation message format as described in the European Telecommunications Standard ETS 300 659-1, and variations and evolutions thereof which is for example used in connection with fixed communication device line protocol.

The term “fixed communication device” as used herein specifically means a telephone handset device that operates in accordance with FXS/FXO procedures, sometimes referred to as a two-wire telephone, a residential phone, or a local phone, where the handset can be connected by a telephone line cord or wirelessly, directly or indirectly (such as via a base station) as an FXO device to the gateway operating as an FXS device, in accordance with known FXS/FXO connection techniques. Such a device can generate DTMF. The term “fixed communication device” as used herein does not encompass cellular communication device capability, such as where the cellular communication device is associated with a subscriber on a cellular communication network.

The term “gateway” is used above in the detailed description and in the claims to specifically mean any of various network devices providing or communicating on VOP networks, that is, a hardware device connecting an internal network with a wide area network (WAN) or the Internet. The gateway can provide network address translation so as to allow the computers in the internal network to share one IP address and Internet connection and Internet connection, and can combine the functions of an IP router, multi-port Ethernet switch and/or wireless access point; the gateway may be located between the modem and the internal network, or a DSL or cable modem may be integrated into the gateway. The gateway can incorporate various proprietary devices and/or devices which are the subject of standardization efforts such as the Home Gateway Initiative (HGI), and the like, and variants or evolutions thereof. Such devices are sometimes colloquially referred to as “residential gateways,” “home gateways,” “home routers,” or “broadband routers.” The designation “VoIP gateway” is used herein to indicate such a gateway specifically including functionality to communicate using VoIP.

It should be noted that the term “network infrastructure device” denotes a device or software that receives communications via a communication network (as described below), determines a next network point to which the communications should be forwarded toward their destinations, and then forwards the communications. Typically the network infrastructure device is assigned a unique Internet protocol (IP) address. Examples of network infrastructure devices include devices and/or software which are sometimes referred to as routers, edge routers, switches, bridges, brouters, gateways, home gateways, media gateways, centralized media gateways, session border controllers, trunk gateways, call servers, hubs, and the like, and variants or evolutions thereof.

Furthermore, the communication networks of interest include those that transmit information in packets, for example, those known as packet switching networks, more particularly using VOP (voice over packet) protocol, and even more particularly using VoIP (voice over IP) protocol, and even more particularly using SIP-formatted packets. Such networks can include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A fixed communication device, comprising:
a transceiver operable to transmit and receive communications to a gateway; and
a processor cooperatively operable with the transceiver, the processor being configured to facilitate
establishing a foreign exchange office (FXO) connection to the gateway over the transceiver;
formatting a message in a multiple data message format (MDMF) message format; and
transmitting the message from the transceiver to the gateway using frequency shift keying (FSK) modulation, after the FXO connection is established.

2. The fixed communication device of claim 1, wherein the message includes a contact address in accordance with the MDMF message format.

3. The fixed communication device of claim 1, further comprising a memory storing an address book, wherein the processor is further configured to receive a selection of a name and a contact address from the address book, and to insert the name and the contact address into MDMF message format in the message prior to the transmitting.

4. The fixed communication device of claim 1, wherein the processor is configured for interacting with the user to input a text message, and embedding the input text message into the message according to the MDMF message format, prior to the transmitting.

5. The fixed communication device of claim 4, wherein the message further includes a name and a contact address in the MDMF message format.

6. The fixed communication device of claim 1, wherein the message in the MDMF message format is transmitted to be used for dialing instead of utilizing dual tone multi- frequency (DTMF) dialing.

7. The fixed communication device of claim 1, wherein the processor is further configured for performing mid-call signaling by transmitting FSK or MDMF messages to the gateway over the transceiver during an established call.

8. A foreign exchange station (FXS) gateway, comprising:
a transceiver operable to transmit and receive communications to a fixed communication device; and
a processor cooperatively operable with the transceiver, the processor being configured to facilitate receiving a message in a multiple data message format (MDMF) message format from the fixed communication device over the transceiver.

9. The FXS gateway of claim 8, wherein the processor is further configured for
performing a voice over Internet protocol (VOIP) setup request using a contact address in the message.

10. The FXS gateway of claim 8, wherein the processor is further configured for making a determination whether the fixed communication device uses dual tone multi-frequency (DTMF) modulation or frequency shift keying (FSK) modulation.

11. The FXS gateway of claim 10, wherein the determination is performed by detecting the FSK modulation signals from the fixed communication device.

12. The FXS gateway of claim 8, wherein the processor is further configured for performing mid-call signaling by receiving FSK or MDMF messages from the fixed communication device over the transceiver during an established call.

13. The FXS gateway of claim 8, wherein the processor is further configured for
making a check whether the message includes a text message; and
when the check is that the message includes the text message, translating the text in the message from MDMF form to a VOIP message, and transmitting the message over a VOIP network.

14. The FXS gateway of claim 8, wherein the message received in the MDMF message format is used for dialing instead of utilizing DTMF dialing.

15. A computer-readable medium comprising instructions for execution by a computer, the instructions including a computer-implemented method for providing messages from a fixed communication device via a foreign exchange station (FXS) gateway, the instructions for implementing:
receiving a message in a multiple data message format (MDMF) message format from a fixed communication device.

16. The computer-readable medium of claim 15, further comprising instructions for
performing a voice over internet protocol (VOIP) setup request using a contact address in the message.

17. The computer-readable medium of claim 15, further comprising instructions for making a determination whether the message uses dual tone multi-frequency (DTMF) modulation or frequency shift keying (FSK) modulation.

18. The computer-readable medium of claim 17, wherein the determination is performed by detecting the FSK modulation signals from the fixed communication device.

19. The computer-readable medium of claim 15, further comprising performing mid-call signaling by receiving FSK or MDMF message from the fixed communication device during an established call.

20. The computer-readable medium of claim 15, further comprising instructions for
making a check whether the message includes a text message; and
when the check is that the message includes the text message, translating the text in the message from MDMF form to a VOIP message, and transmitting the message over a VOIP network.
